(19) United States
(12) Patent Application Publication
(10) Pub. No.: US 2007/0252388 A1
(43) Pub. Date: Nov. 1, 2007

(54) Pipe joint

(75) Inventors: Masaru Ochiai, Komaki-city (JP); Katsumi Tsuchimoto, Komaki-city (JP); Fumiaki Nakamura, Kariya-city (JP); Takashi Ono, Okazaki-city (JP); Kinji Ochiai, Kasugai-city (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); DENSO Airs Corporation, Anjo-city (JP)

(21) Appl. No.: 11/716,717

(22) Filed: Mar. 9, 2007

(30) Foreign Application Priority Data
Mar. 13, 2006 (JP) 2006-066938
Nov. 22, 2005 (JP) 2005-336696

(51) Int. Cl. F16L 25/00

(52) U.S. Cl. 285/333; 285/332.4

(57) ABSTRACT

A pipe joint has a joint main body, a union nut connected to the joint main body, and a lock ring. The lock ring has a tubular wall, and a first axial end and a second axial end of the tubular wall are deformable by inner walls of tapered hole portion of the joint main body and the union nut. The lock ring has a first tapered opening portion providing a first groove for receiving a first end of a first pipe member and a second tapered opening portion providing a second groove for receiving a second end of a second pipe member, in a radial inside of the tubular wall. A radial outer surface of the first tapered opening portion and a radial outer surface of the second tapered opening portion are tapered such that the first groove and the second groove are narrowed toward its ends, respectively.

### CROSS REFERENCE TO RELATED APPLICATION

This application is based on Japanese Patent Applications No. 2005-336696 filed on Nov. 22, 2005 and No. 2006-66938 filed on Mar. 13, 2006, the disclosures of which are incorporated herein by reference.

### FIELD OF THE INVENTION

The present invention relates to a pipe joint.

### BACKGROUND OF THE INVENTION

Various pipe joining methods are known. For example, it is known to weld ends of two pipes in a condition that the ends of the pipes are opposed to each other or in a condition that the end of one pipe is inserted in the end of another pipe. To weld the pipes with sufficient strength and high reliability of sealing at welded portions, however, skill and experience are required. Also, provision against fire is required.

Further, it is known to employ a pipe joint shown in FIG. 3, as a method without requiring such experience and firearms. As shown in FIG. 3, a pipe 101 is coupled to a tubular joint main body 102 with a union nut 103 and a tubular sleeve 104. This method is for example disclosed in U.S. patent publication No. 2006/0091672 A1 (JP-A-2004-44633).

The joint main body 102 has a screwed portion 102a on its first end to be connected to an object such as an external device. The joint main body 102 further has an insertion hole 102c on its second end for receiving an end of the pipe 101, and an axially outer end of the insertion hole 102c is tapered such that an inner diameter thereof reduces toward an axially inside of the joint main body 102.

Also, a first end of the union nut 103 is screwed on the second end of the joint main body 102. The union nut 103 has an inner flange 103b on an inner periphery of its second end. The inner flange 103b defines an insertion hole 103a for inserting the pipe 101 herein. Thus, an inner diameter of the union nut 103 is reduced at the inner flange 103b.

The sleeve 104 has a front ring 104a and a back-up ring 104b. The front ring 104a has a substantially conical shape such that its outer peripheral wall mate with an inner wall of the taper hole 102b of the joint main body 102. The front ring 104a has a taper hole 104c on its second end and a first end of the back-up ring 104b is received in the taper hole 104c of the front ring 104a.

In coupling the pipe 101he end of the pipe 101 is inserted into the union nut 103, the back-up ring 104b and the front ring 104a in this order, and the end of the pipe 101 is further inserted into the insertion hole 102c of the joint main body 102. Then, the union nut 103 is screwed onto the second end of the joint main body 103.

As screwing the union nut 103, the inner flange 103b biases a second end of the back-up ring 104b such that the first end of the back-up ring 104b is received in the taper hole 104c of the front ring 104a and presses the front ring 104a toward the taper hole 102b of the joint main body 102. When the union nut 103 is further screwed, the first end of the front ring 104a is slid into the taper hole 102b of the joint main body 102, and the front ring and the back-up ring 104b are deformed in a radial inside direction and bit in the pipe 101.

As such, the pipe 101 is fixed by the sleeve 104 bit into the pipe 101. Also, a clearance between the joint main body 102 and the pipe 101 are sealed by this sleeve 104. In this structure, however, if the pipe 101 is pulled or jerked, a condition of the sleeve 104 biting in the pipe 101 is will be reduced. Therefore, it will be difficult to maintain a pipe-holding condition and a sealing condition by the sleeve 104 for a long time use.

### SUMMARY OF THE INVENTION

The present invention is made in view of the foregoing matter, and it is an object of the present invention to provide a pipe joint with an enhanced reliability.

According to an aspect of the present invention, a pipe joint for coupling a first end of a first pipe member and a second end of a second pipe member has a joint main body, a union nut and a lock ring. The joint main body has a substantially tubular shape and defines a first opening at its first end for receiving the first pipe member and a second opening at its second end. The joint main body includes a tapered hole portion defining a tapered hole axially between the first end and the second end. The first opening is in communication with the second opening through the tapered hole, and a diameter of the tapered hole reduces toward the first opening.

The union nut has a substantially tubular shape and defines a first opening at its first end and a second opening at its second end for receiving the second pipe member. The first end of the union nut is connectable with the second end of the joint main body. The union nut includes a tapered hole portion defining a tapered hole axially between the first end and the second end. The first opening is in communication with the second opening through the tapered hole, and a diameter of the tapered hole reduces toward the second opening.

The lock ring has a tubular wall that has hardness less than that of the joint main body and the union nut. The tubular wall has a first axial end defining a first opening for receiving the first end of the first pipe member and a second axial end defining a second opening for receiving the second end of the second pipe member. The first and second axial ends are deformable according to a compression force in the axial direction.

The lock ring further has a first tapered opening portion and a second tapered opening portion in a radial inside of the tubular wall. The first tapered opening portion and the second tapered opening portion are opposite in the axial direction and define an opening in a radial inside thereof for allowing communication between the first pipe member and the second pipe member.

The first tapered opening portion of the lock ring has a first radial outer surface that is spaced from an inner surface of the tubular wall and provides a first groove between itself and the inner surface of the tubular wall for receiving the first end of the first pipe member. The first radial outer surface is inclined relative to an axis of the tubular wall such that a distance between the inner surface of the tubular wall and the first radial outer surface reduces toward an end of the first groove.

The second tapered opening portion of the lock ring has a second radial outer surface that is spaced from the inner surface of the tubular wall and provides a second groove between itself and the inner surface of the tubular wall for receiving the second end of the second pipe member. The second radial outer surface is inclined relative to the axis of the tubular wall such that a distance between the inner surface of the tubular wall and the second radial outer surface reduces toward an end of the second groove.

The lock ring is received in a radial inside of the joint main body and the union nut such that a radial outer edge of the first axial end of the tubular wall is contactable with the tapered hole portion of the joint main body and a radial outer edge of the second axial end of the tubular wall is contactable with the tapered hole portion of the union nut.

In the above structure, when the first end of the union nut is engaged with the second end of the joint main body in the axial direction, the first and second axial ends of the tubular wall of the lock ring are deformed by the tapered hole portions of the joint main body and the union nut, and dug into the first and second pipe members. With this, the first end of the first pipe member and the second end of the second pipe member are urged into the first and second grooves of the first and second tapered opening portions. At this time, the radial inner edges of the first and second ends of the first and second pipe members are deformed along the first and second radial outer surfaces of the tapered opening portions such that inner diameters of the first and second ends of the first and second pipes are increased.

Accordingly, the first and second axial ends of the tubular wall are deformed such that radial outer surfaces thereof are in contact with the tapered hole portions of the joint main body and the union nut. Further, the first and second ends of the first and second pipes are deformed to be in contact with the inner surface of the tubular wall and the first and second radial outer surfaces of the tapered opening portions. Therefore, the first and second ends of the first and second pipe members are sealed at radial outer side and radial inner side thereof. Thus, the first and second pipe members are fluid-tightly connected. Further, the first and second pipe members are securely coupled with the pipe joint. As such, strength of the joint increases and hence reliability improves.

In addition, two pipe members are coupled at the same time by connecting the union nut to the joint main body. Therefore, the efficiency of workers and productivity improve. Furthermore, manufacturing costs will reduce.

### BRIEF DESCRIPTION OF THE DRAWINGS

Other objects, features and advantages of the present invention will become more apparent from the following detailed description made with reference to the accompanying drawings, in which:

FIG. 1 is a longitudinal cross-sectional view of a pipe joint according to an embodiment of the present invention;

FIG. 2 is a longitudinal cross-sectional view of the pipe joint for showing a coupling process according to the embodiment of the present invention; and

FIG. 3 is a longitudinal cross-sectional view of a pipe joint of a prior art.

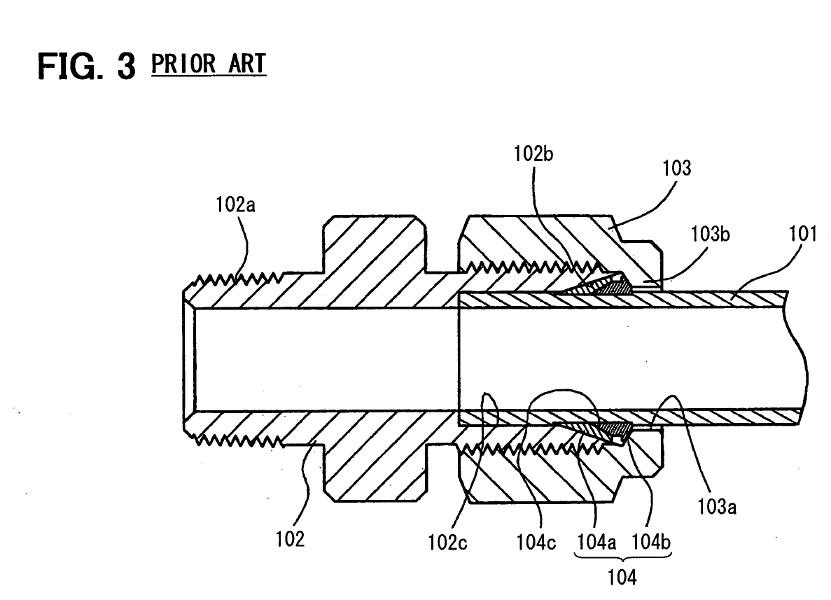

### DETAILED DESCRIPTION OF EXAMPLE EMBODIMENT

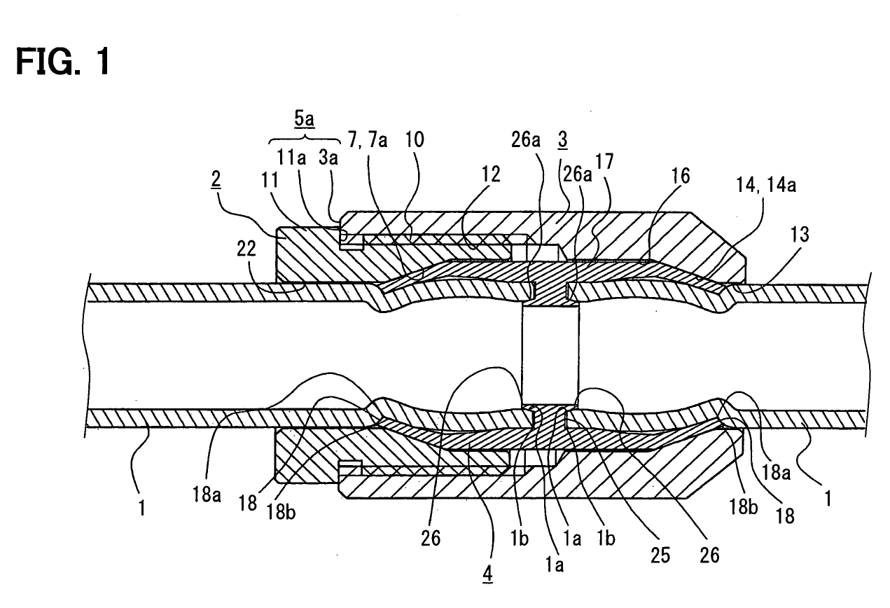

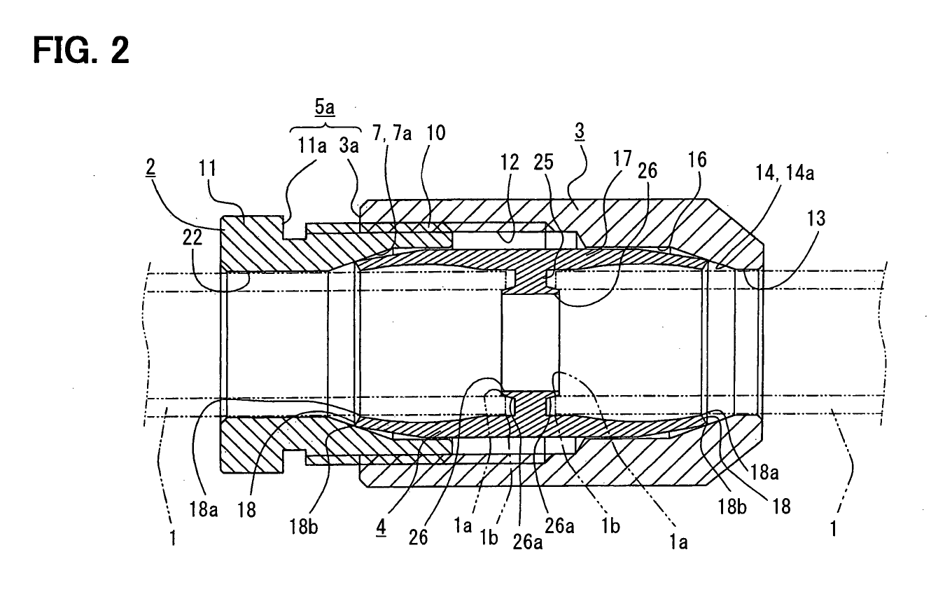

An embodiment of the present invention will be described with reference to FIGS. 1 and 2. As shown in FIG. 1, a pipe joint is used for coupling straight ends of two pipes 1 at the same time. Hereafter, a right pipe 1 in FIGS. 1 and 2 is referred to as a first pipe 1 and a left pipe 1 in FIGS. 1 and 2 is referred to as a second pipe 1.

The pipe joint generally has a joint main body 2, a union nut 3 screwed on the joint main body 2, and a lock ring 4 engaging with the first pipe 1a and the second pipe 1b on an inner periphery of the joint main body 2 and the union nut 3. Also, the pipe joint has a screwing distance constraining part 5a for constraining the distance or amount of screwing of the union nut 3 relative to the joint main body 2.

The joint main body 2 is for example made of a metal having predetermined hardness, such as carbon steel, stainless steel, or copper alloy. The joint main body 2 has a generally tubular shape. The joint main body 2 has a first opening 22 on its first end (left end in FIG. 1) as an insertion hole for inserting the first pipe 1 therein and a second opening on its second end.

Also, the joint main body 2 has a tapered hole portion 7 defining a tapered hole axially between the first opening 22 and the second opening. Specifically, in the tapered hole portion 7, a diameter of the tapered hole gradually increases from the first opening 22 toward the second opening. A diameter of the second opening of the joint main body 2 is equal to a maximum diameter of the tapered hole of the tapered portion 7.

The joint main body 2 has a male screw portion 10 on an outer periphery of the second end to be engaged with the union nut 3. The joint main body 2 also has a flange portion 1 on an outer periphery of its first end. The flange portion 1 for example has a hexagonal shape when viewed in an axial direction so as to be held by a jig such as a wrench.

The union nut 3 is made of a material having hardness equal to that of the joint main body 2. The union nut 3 can be made of the same material as the joint main body 2. For example, the union nut 3 has a generally tubular shape defining a through hole therein. A radial inside wall of a first end of the union nut 3 is formed with screwed portion. Thus, the first end of the union nut 3 provides a screwed hole portion 12 for engaging with the male screw portion 10 of the joint main body 2. Namely, the union nut 3 is configured such that its first end is screwed on and engaged with the outer periphery of the second end of the joint main body 2.

The union nut 3 has an insertion opening 13 on its second end for inserting the second pipe 1 therein. Also, the union nut 3 has a tapered hole portion 14 defining a tapered hole that is in communication with the insertion opening 13. In the tapered hole portion 14, a diameter of the tapered hole gradually increases in a screwing direction, i.e., toward the first end of the union nut 3.

The union nut 3 further has a circular hole portion 16 defining a circular hole (e.g., perfect circular hole) axially between the tapered hole portion 14 and the screwed hole portion 12. A diameter of the circular hole is equal to the maximum diameter of the tapered hole of the tapered hole portion 14 and is smaller than a diameter of the screwed hole of the screwed hole portion 12.

The diameter of the circular hole of the circular hole portion 16 is equal to an inner diameter of the second end of the joint main body 2. The circular hole portion 16 has a predetermined axial length. The insertion opening 13 is in communication with the screwed hole of the screwed hole portion 12 through the tapered hole of the tapered hole portion 14 and the circular hole of the circular hole portion 16.

Also, the union nut 3 has a first axial end face 3a at the first end. The flange portion 11 has an axial end face (right end face) 11a to be opposed to the first axial end face 3a of the union nut 3 in the axial direction. In screwing the union nut 3 onto the joint main body 2, the axial end face 11a of the joint main body 2 comes in contact with the first axial end face 3a of the union nut 3. Thus, the axial end face 11a provides a barrier wall for constraining the axial distance or amount of screwing of the union nut 3 relative to the joint main body 2 at a predetermined screwing position.

The lock ring 4 is a generally tubular member and includes a tubular peripheral wall (tubular wall) 17. The lock ring 4 is made of a material (e.g., metal) that has hardness greater than that of the pipes 1 and less than that of the joint main body 2 and the union nut 3. Specifically, the peripheral wall 17 slightly curves in a radially inward direction toward its first and second axial ends 18. In a longitudinal cross-section shown in FIG. 2, the peripheral wall 17 has a generally arch or bow-like shape, for example. Also, an axially middle portion of the peripheral wall 17 has a thickness greater than that of the first and second ends 18. Thus, the peripheral wall 17 provides a generally gourd-shaped hollow space therein.

As such, the first and second ends 18 of the peripheral wall 17 has a characteristic of being elastically deformable relative to a compression load in the axial direction. Namely, when the compression load within a predetermined range (e.g., within a limit of elasticity) is applied to the peripheral wall 17, the peripheral wall 17 elastically deforms such that the first and second ends 18 increase those curvature and expand in a radial outward direction.

Further, the lock ring 4 has an intermediate projection (reduced diameter step portion) 25 projecting from an inner surface of the peripheral wall 17 at a substantially middle portion thereof and extending in a circumferential direction of the peripheral wall 17 as in an annular shape. The intermediate projection 25 provides an opening on its radial inside for allowing communication between the first and second pipes 1. The intermediate projection 25 has first and second axial faces to be opposed to the ends of the first and second pipes 1.

The lock ring 4 further has end projections 26 projecting from radial inside ends of the intermediate projection 25 in the axial direction. The intermediate projection 25 and the end projections 26 provide an opening on a radially inside thereof for allowing communication between the first and second pipes 1.

The projections 26 are spaced from the inner surface of the peripheral wall 17 for providing annular opening (grooves) by the first and second axial faces of the intermediate projection 25, the inner surface of the peripheral wall 17 and radial outer surfaces 26a of the end projections 26. Further, the radial outer surfaces 26a are tapered such that a radial dimension of the annular opening (grooves) are reduced toward the first and second axial faces of the intermediate projection 25. Thus, the end projections 26 provide tapered opening portions for receiving the ends of the first and second pipes 1.

An axial length of the peripheral wall 17 and inner and outer diameters of the first and second axial ends 18 are determined such that the radial inner edges 18a of the ends 18 can contact and abut on the outer peripheral surfaces of the first and second pipes 1 and the radial outer edges 18b of the first and second ends 18 can contact and abut on an inner wall 7a of the tapered hole portion 7 and an inner wall 14a of the tapered hole portion 14, when the ends of the first and second pipes 1a, 1b are inserted into the lock ring 4, as shown in FIG. 2.

When the union nut 3 is screwed onto the joint main body 2, an axial distance of the tapered hole portions 7, 14 is reduced. At this time, the radial outer edges 18b of the first and second ends 18 of the lock ring 4 are pressed by the inner walls 7a, 14a of the tapered hole portions 7, 14 in the axial direction and hence the first and second end 18 are more curved. The screwing distance constraining means 5a constrains the amount of screwing of the union nut 3 onto the joint main body 2 (i.e., the distance of screwing of the union nut 3 relative to the joint main body 2) such that the first and second ends 18, which are compressed by the inner walls 7a, 14a of the tapered hole portions 7, 14, restrain the predetermined curvature within its limit of elasticity.

Specifically, the screwing distance constraining means 5a is configured such that the first axial end face 3a of the union nut 3 is brought into contact with the barrier wall 1a of the flange portion 1 of the joint main body 2 when the union nut 3 is screwed onto the joint main body 2 by the predetermined distance. As the first axial end face 3a is received by the barrier 1a, the screwing of the union nut 3 is limited and the ends 18 are maintained in the predetermined curvature.

The first and second pipes 1 are coupled by the above pipe joint in the following manner. First, the end of the first pipe 1 is inserted into the insertion opening 22 of the joint main body 2 and the end the second pipe 1 is inserted into the insertion opening 13 of the union nut 3. Further, the ends of the first and second pipes 1 are inserted in the lock ring 4 through the first and second ends 18, as shown in FIG. 2. Then, the first end of the union nut 3 is screwed onto the second end of the joint main body 2.

As the union nut 3 is screwed onto the joint main body 2, radial inner edges 1a of the ends of the first and second pipes 1 are pressed against the tapered radialy outer walls 26a of the end projections 26 and received in the annular openings defined between the end projections 26, the intermediate projection 25 and the peripheral wall 17. As such, the insertion length of the first pipe 1 into the lock ring 4 is set substantially equal to that of the second pipe 1.

In the pipe joint coupled as above, the lock ring 4 is located radially inside of the joint main body 2 and the union nut 3 and radially outside of the first and second pipes 1.

Specifically, in a condition shown in FIG. 2, i.e., in a condition that the union nut 3 is not completely fastened to the joint main body 2, the first end 18 of the lock ring 4 is located in a space defined between the inner wall 7a of the tapered hole portion 7 of the joint main body 2 and the outer periphery of the end of the first pipe 1. Likewise, the second end 18 of the lock ring 4 is located in a space defined between the inner wall 14a of the tapered hole portion 14 of the union nut 3 and the outer periphery of the end of the second pipe 1. In this condition, the lock ring 4 is disposed such that the radial inner edges 18a of the first and second ends 18 of the lock ring 4 are contactable with the outer peripheral surfaces of the pipes 1, and the radial outer edges 18b of the ends 18 of the lock ring 4 are contactable with the inner walls 7a, 14a of the tapered hole portions 7, 14, respectively.

From this condition shown in FIG. 2, the union nut 3 is screwed onto the joint main body 2 up to a position where the first axial end face 3a is brought into contact with the barrier wall 1a of the joint main body 2 as shown in FIG. 1. As an axial distance between the tapered hole portion 7 of the joint main body 2 and the tapered hole portion 14 of the union nut 3 reduces with screwing of the union nut 3, the radial outer edges 18b of the first and second ends 18 of the lock ring 4 are brought into contact with and pressed by the inner walls 7a, 14a of the tapered hole portions 7, 14. Further, the compression force is exerted to the peripheral wall 17 of the lock ring 4 by the inner wall 7a, 14a of the tapered hole portions 7, 14 in the axial direction.

By this compression force, the first and second ends 18 of the lock ring 4 are elastically deformed and more curved such that the outer peripheral surfaces of the ends 18 are in closely contact with the inner walls 7a, 14a of the tapered hole portions 7, 14, as shown in FIG. 1. As such, the clearances between the first and second ends 18 of the lock ring 4 and the inner walls 7a, 14a of the tapered hole portions 7, 14 are sealed.

Furthermore, the radial inner edges 18a of the ends 18 of the lock ring 4 bite or dig into the first and second pipes 1, so as to partly constrict the outer peripheral portion of the first and second pipes 1. As such, the radial inner edges 18a of the ends 18 of the lock ring 4 are in closely contact with the first and second pipes 1 and engaged with the constricted portions of the first and second pipes 1. Accordingly, the clearances between the radial inner edges 18a of the end 18 and the outer peripheral surfaces of the pipes 1 are fully sealed. Further, the first and second pipes 1 are engaged with and held by the lock ring 4 so as not to be easily separated.

Also, as the lock ring 4 bite or dig into the pipes 1 with the screwing of the union nut 3, the ends of the pipes 1 are urged more inside of the annular openings defined between the peripheral wall 17 and the end projections 26, as shown in FIG. 1. At this time, the ends of the first and second pipes 1 are deformed along the tapered radially outer walls 26a of the end projections 26, so the inner diameter of the ends of the pipes 1 are increased.

Namely, the ends of the first and second pipes 1 are deformed such that the radial inner edges 1a, 1b of the ends of the pipes 1 are in closely contact with the tapered radially outer walls 26a of the end projections 26, and the radial outer edges 1b of the ends of the pipes 1 are in closely contact with the inner surface of the peripheral wall 17. Accordingly, the end of each pipe 1 is double-sealed on its both radial inner and outer edges 1a, 1b.

As described above, two pipes 1 are coupled at the same time by merely screwing the union nut 3 onto the joint main body 2. Further, two pipes 1 are securely held by the deformed end 18a of the lock ring 4 and sealed by the ends 18a and the end projections 26.

The first and second pipes 1 are not limited to straight pipes. Also, one of or both of the first and second pipes 1 may be tubular portions provided as a part of a device.

The example embodiments of the present invention are described above. However, the present invention is not limited to the above example embodiment, but may be implemented in other ways without departing from the spirit of the invention.

What is claimed is:

1. A pipe joint for coupling a first end of a first pipe member and a second end of a second pipe member, the pipe joint comprising:
a joint main body having a substantially tubular shape and defining a first opening at its first end for receiving the first pipe member and a second opening at its second end, the joint main body including a tapered hole portion defining a tapered hole axially between the first end and the second end, wherein the first opening is in communication with the second opening through the tapered hole, and a diameter of the tapered hole reduces toward the first opening;
a union nut having a substantially tubular shape and defining a first opening at its first end and a second opening at its second end for receiving the second pipe member, the first end of the union nut connectable with the second end of the joint main body, the union nut including a tapered hole portion defining a tapered hole axially between the first end and the second end, wherein the first opening is in communication with the second opening through the tapered hole, and a diameter of the tapered hole reduces toward the second opening; and
a lock ring having a tubular wall that has a substantially tubular shape and has hardness less than that of the joint main body and the union nut,
wherein the tubular wall has a first axial end defining a first opening for receiving the first end of the first pipe member and a second axial end defining a second opening for receiving the second end of the second pipe member, and the first and second axial ends are deformable according to a compression force in an axial direction,
wherein the lock ring further has a first tapered opening portion and a second tapered opening portion in a radial inside of the tubular wall, the first tapered opening portion and the second tapered opening portion are opposite in the axial direction and define an opening in a radial inside thereof for allowing communication between the first pipe member and the second pipe member,
wherein the first tapered opening portion has a first radial outer surface that is spaced from an inner surface of the tubular wall and provides a first groove between itself and the inner surface of the tubular wall for receiving the first end of the first pipe member, and the first radial outer surface is inclined relative to an axis of the tubular wall such that a distance between the inner surface of the tubular wall and the first radial outer surface reduces toward an end of the first groove,
wherein the second tapered opening portion has a second radial outer surface that is spaced from the inner surface of the tubular wall and provides a second groove between itself and the inner surface of the tubular wall for receiving the second end of the second pipe member, and the second radial outer surface is inclined relative to the axis of the tubular wall such that a distance between the inner surface of the tubular wall and the second radial outer surface reduces toward an end of the second groove, and
wherein the lock ring is received in a radial inside of the joint main body and the union nut such that a radial outer edge of the first axial end of the tubular wall is contactable with the tapered hole portion of the joint main body and a radial outer edge of the second axial end of the tubular wall is contactable with the tapered hole portion of the union nut.

2. The pipe joint according to claim 1, wherein
the lock ring is configured such that a radial inner edge of the first axial end of the tubular wall is contactable with an outer surface of the first pipe member and a radial inner edge of the first axial end of the tubular wall is contactable with an outer surface of the second pipe member in a condition that the first end of the first pipe member and the second end of the second pipe member are disposed in the first axial end and the second axial end of the tubular wall, respectively.

3. The pipe joint according to claim 1, wherein
the first tapered opening portion of the lock ring is configured to deform a radial inner edge of the first end of the first pipe member such that the radial inner edge of the first end of the first pipe member is in contact with the radial outer surface of the first tapered opening portion and a radial outer edge of the first end of the first pipe member is in contact with the inner surface of the tubular wall and
the second tapered opening portion of the lock ring is configured to deform a radial inner edge of the second end of the second pipe member such that the radial inner edge of the second end of the second pipe member is in contact with the radial outer surface of the second tapered opening portion and a radial outer edge of the second end of the second pipe member is in contact with the inner surface of the tubular wall.

4. The pipe joint according to claim 1, wherein
the first axial end and the second axial end of the tubular wall of the lock ring are curved relative to the axis of the tubular wall such that the tubular wall has a substantially bow-shape in a cross-section defined in a direction parallel to the axis of the tubular wall, and
the first and second axial ends of the tubular wall are expandable in a radial direction according to the compression force in the axial direction.

5. The pipe joint according to claim 1, wherein
the lock ring has an intermediate projection projecting from the inner surface of the tubular wall in a radial inside direction and defining an opening at its radial inside, and.
the first tapered opening portion and the second tapered opening portion extend from a radial inside end of the intermediate projection in axially opposite directions.

6. The pipe joint according to claim 5, wherein
the intermediate projection has a first axial face providing the end of the first groove and a second axial face providing the end of the second groove.

7. The pipe joint according to claim 1, wherein
the joint main body has a first screwed portion on an outer peripheral surface of its second end,
the union nut has a second screwed portion on an inner peripheral surface of its first end, and
the first end of the union nut is fastened on the second end of the joint main body through the first and second screwed portions.

8. The pipe joint according to claim 7, wherein
the joint main body has a flange portion expanding in a radially outward direction,
the union nut has an axial end face at the first end thereof, and
the axial end face of the union nut is opposed to the flange portion of the joint main body in the axial direction.

9. The pipe joint according to claim 8, wherein
the axial end face of the union nut is received by the flange portion so as to restrain an axial distance between the tapered hole portion of the joint main body and the tapered hole portion of the union nut such that the first and second axial ends of the tubular wall of the lock ring are maintained in a predetermined deformed condition.

10. The pipe joint according to claim 8, wherein
in a condition that the axial end face of the union nut is in contact with the flange portion of the joint main body, the first and second axial ends of the tubular wall of the lock ring are deformed such that radial inside edges of the first and second axial ends are deformed to be constricted in a radially inward direction.

11. The pipe joint according to claim 1, wherein
the lock ring is configured such that a radial outer surface of the first axial end of the tubular wall is in contact with the tapered hole portion of the joint main body, the radial inner edge of the first axial end of the tubular wall is engaged with an outer peripheral surface of the first pipe member, a radial outer surface of the second axial end of the tubular wall is in contact with the tapered hole portion of the union nut, and the radial inner edge of the second axial end of the tubular wall is engaged with an outer peripheral surface of the second pipe member, in a condition that the first end of the first pipe member and the second end of the second pipe member are received in the first groove and the second groove of the lock ring.

12. The pipe joint according to claim 1, wherein the first and second tapered opening portions are disposed in a substantially middle position of the tubular wall with respect to the axial direction.

13. The pipe joint according to claim 1, wherein
the lock ring is configured such that the first and second axial ends of the tubular wall are deformed by the tapered hole portions of the joint main body and the union nut, respectively, to bite into the first and second pipe members, and the first and second ends of the first and second pipe members are urged into the first and second grooves by deformation of the first and second axial ends of the tubular wall while deforming radial inner edges of the first and second ends of the first and second pipe members along the first and second radial outer surfaces of the first and second tapered opening portions, respectively, as an axial distance between the tapered hole portion of the joint main body and the tapered hole portion of the union nut reduces.

14. The pipe joint according to claim 1, wherein
the joint main body, the union nut and the lock ring are metallic members, and
the lock ring has hardness greater than that of the first and second pipe members.
